(19) United States
(12) Patent Application Publication
(10) Pub. No.: US 2005/0100865 A1
(43) Pub. Date: May 12, 2005

(54) Prosthesis for a tooth, and set for such prosthesis

(76) Inventor: Josef Jansen, Almere (NL)

Correspondence Address: Denta Net Holding BV, Antennestraat 86, 1322 AS Almere, NL

(21) Appl. No.: 10/499,736

(22) PCT Filed: Dec. 20, 2002
(86) PCT No.: PCT/NL02/00855

(30) Foreign Application Priority Data
Dec. 20, 2001 (NL) 1019628

(51) Int. Cl. A61C 13/12

(52) U.S. Cl. 433/182

(57) ABSTRACT

A prosthetic construction between two natural pillar elements in a set of teeth, for replacement of a tooth, comprising two anchor elements, each fixed to a respective pillar, and a dental prosthesis provided with two fixing parts each rigidly fixed to a respective anchor. One of the fixing parts is movably connected to the prosthesis, in order to compensate for movements between the pillar elements.

The invention relates to a prosthetic construction between two natural pillar elements in a set of teeth, for the replacement of a tooth, comprising two anchor elements, each fixed to a respective pillar, and a dental prosthesis provided with two fixing parts, each rigidly fixed to a respective anchor, one of the fixing parts being movably connected to the prosthesis.

Such a prosthetic construction is known from U.S. Pat. No. 4,813,873. By means of this known prosthetic construction, a dental prosthesis can be suspended securely between two sound teeth. The fixing devices with these so-called sound pillar elements must have such strength and reliability that an acceptable service life of the prosthesis can be guaranteed. Furthermore, the fixing devices must be capable of withstanding the considerable forces to which the prosthesis is exposed, particularly when it is used in the molar region.

However, it is found in practice that it is precisely in that molar region that a substantial percentage of prosthetic constructions work loose and give way prematurely. It appears that this detachment is caused by the constant, albeit minuscule movements that the pillar elements make relative to each other in the buccal, lingual and palatine direction. As a result of these constant movements, the acid-etch or adhesive bridges with the pillar elements are weakened. The limited bond strength of cements permitted in dentistry is the main cause of this weakening. Those cements that are acceptable from a medical point of view are not capable of absorbing the abovementioned movements.

The object of the invention is therefore to provide a prosthetic construction that is better capable of withstanding the movements that constantly occur in the set of teeth. That object is achieved by the fact that a hollow part is present in the prosthesis, and one of the anchors comprises a projection that is movably accommodated in the hollow part. The presence of said movable connection in the prosthetic construction means that no internal forces can occur in the fixing devices. The result of this is that these fixing devices are subjected to a considerably less heavy load than is the case with the known prosthetic constructions, so that a considerable service life can be guaranteed.

In particular, the connection between the fixing part that is movably connected to the prosthesis, on the one hand, and the pillar element, on the other hand, can permit a translation according to one degree of freedom. Said translation is preferably directed from the one pillar element to the other pillar element. The other fixing part is rigidly connected to the corresponding pillar element.

The connection between the fixing part that is movably connected to the prosthesis, on the one hand, and the pillar element, on the other hand, can permit not only a translation, but also a rotation. The axis of rotation in this case extends from the one pillar element to the other.

The movable connection can be designed in all kinds of ways. The preferred way is a movable connection comprising telescopic parts. The telescopic parts can have interactive surfaces with a circular cross section. Such an embodiment provides a very stable support for the prosthesis, while the required mobility is still ensured.

The fixing parts and the anchors can be in the form of integral pairs. According to an alternative embodiment, the fixing parts and the anchors can form separate parts, in the case of which the anchor and fixing element forming the pair that produces the rigid fixing are stably supported relative to each other, owing to the non-round shapes. Furthermore, the fixing parts can each in the usual manner bear a wing that is fixed to a respective pillar element.

The invention further relates to a set for producing the prosthetic construction, which set comprises an anchor element for fixing to a natural pillar element in a set of teeth, a fixing part that can be rigidly connected to the anchor element, and a connecting part that can be rigidly connected to a dental prosthesis and can be movably connected to the fixing part.

The connection between the connecting part and the fixing part permits a translation, and the connection between the connecting part and the fixing element can also permit at least one rotation.

The connecting part grips around the fixing part in such a way that the fixing part and the connecting part are movable in a direction relative to each other, and transversely to that direction are blocked relative to each other; the connection between the connecting part and the fixing part can, for example, be telescopic.

The anchor element and the fixing part can be of corresponding non-round shapes. Together, they can be pushed laterally over the anchor element, thereby forming a close fit.

A reliable connection between the anchor element and the fixing part can be obtained by means of corresponding shapes or form closure, for example a saddle shape.

The connecting part can have a closed end wall and be open on the opposite side, in such a way that the fixing part can be pushed through the open side into the connecting part. The end wall provides a good closure, so that food residues, bacteria and the like are prevented from entering.

The anchor element can be fixed on the natural pillar element in various ways. For instance, the anchor element can have a pin that can be fixed in a hole drilled in a natural pillar element.

According to another embodiment, the anchor element can be provided with an inlay. Said inlay is placed in the prepared chewing surface of a natural pillar element.

The invention will be explained in greater detail below with reference to an exemplary embodiment illustrated in the figures.

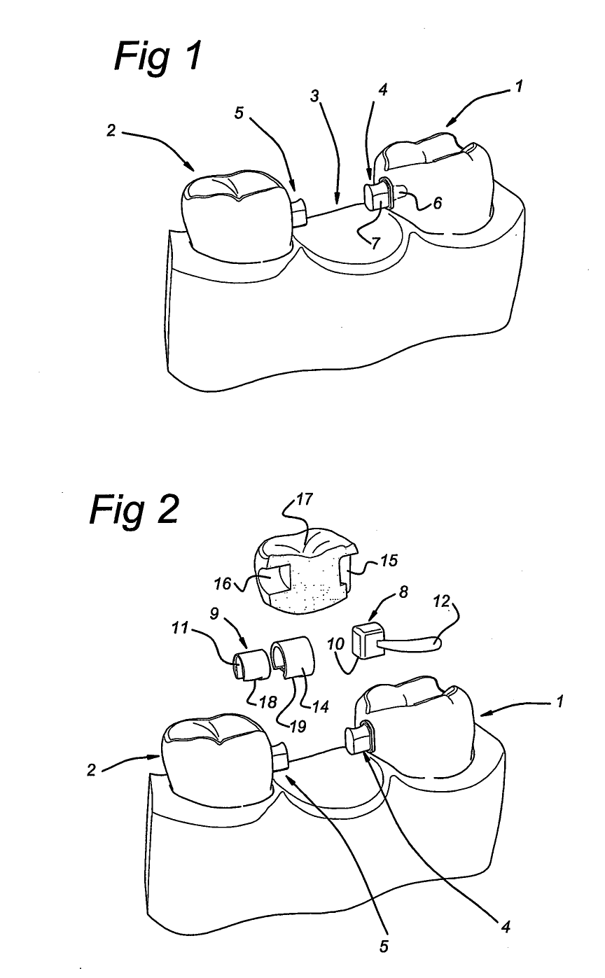

FIG. 1 shows a part of a set of teeth with two molars, between which a prosthetic construction according to the invention has to be fitted.

FIG. 2 shows the various parts of the prosthetic construction according to the invention, in the disassembled state.

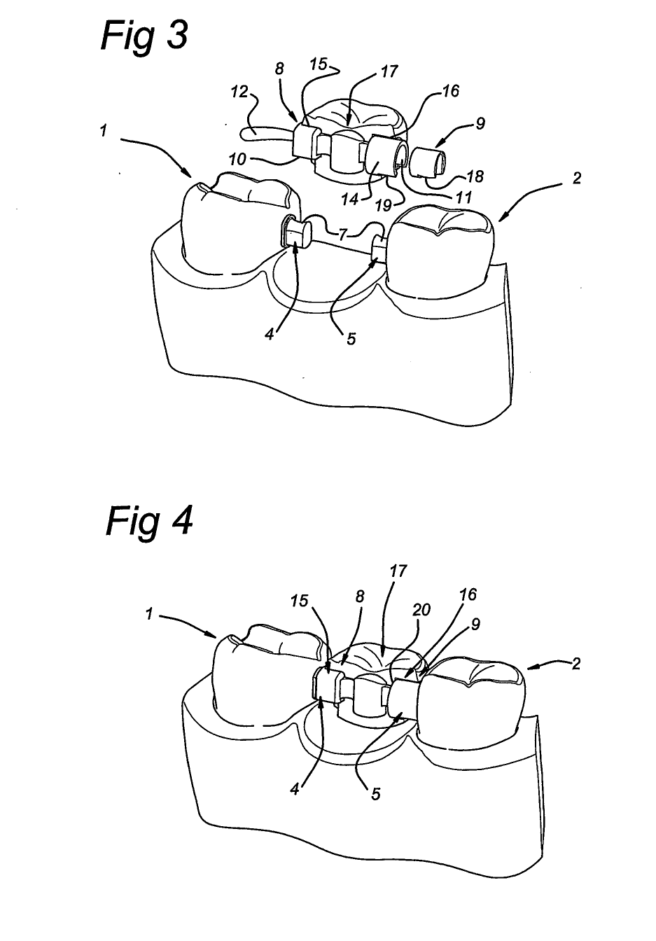

FIG. 3 shows another prosthetic construction, ready for fitting.

FIG. 4 shows the fitted prosthetic construction according to FIG. 3.

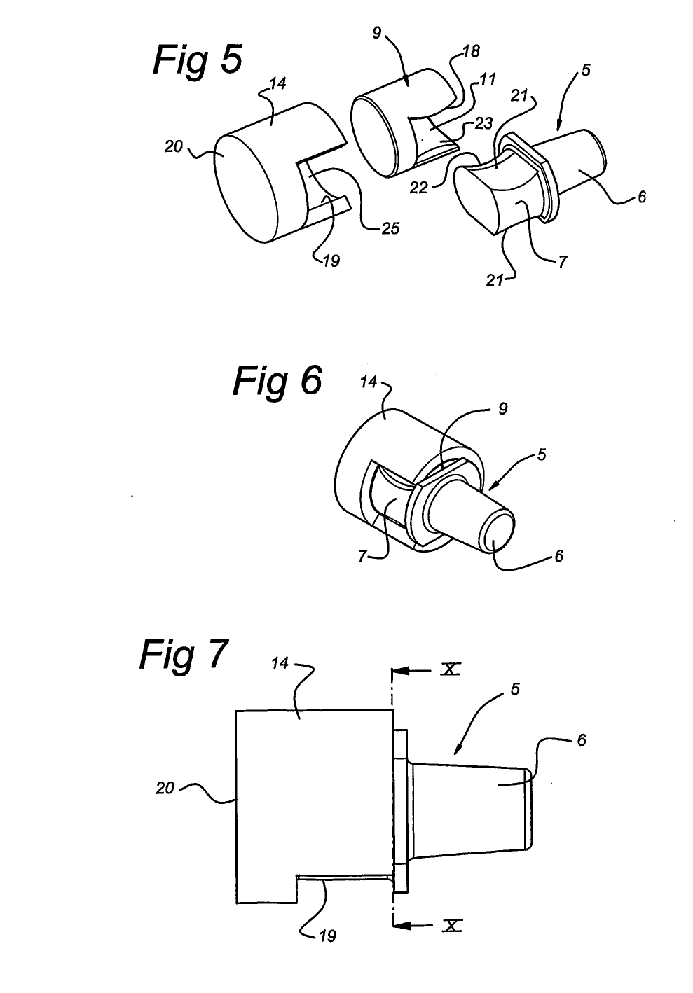

FIG. 5 shows a set, in the disassembled state, for use in the prosthetic construction.

FIG. 6 shows the set according to FIG. 5, in the assembled state.

FIG. 7 shows a side view of the set.

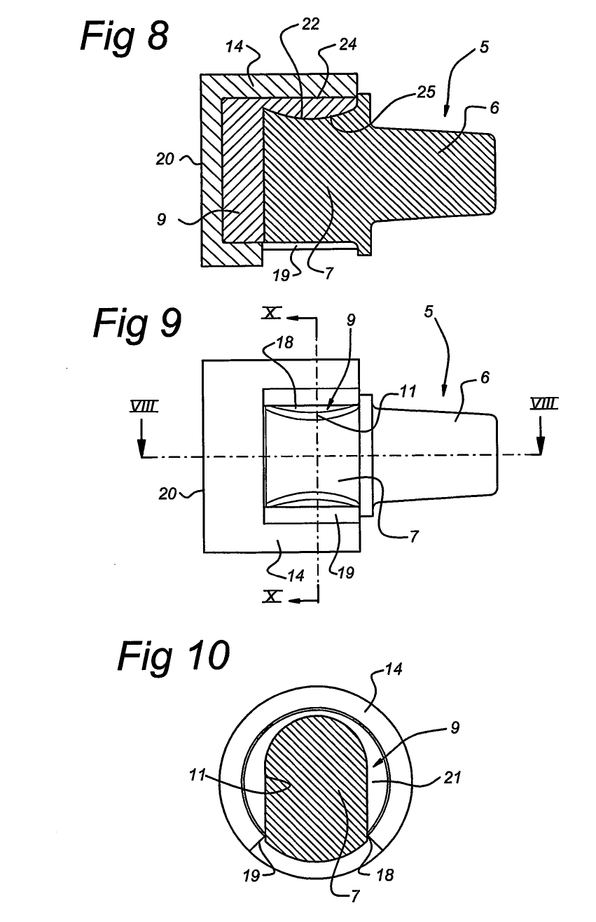

FIG. 8 shows a cross section along the line VIII-VIII of FIG. 9.

FIG. 9 shows a bottom view of the set.

FIG. 10 shows a front view along the line X-X of the set.

The part of a set of teeth shown in FIG. 1 comprises two sound pillar elements or teeth 1, 2, between which an open space 3 is present, in which space a dental prosthesis has to be fitted. Two holes have already been drilled in the sound pillar elements 1, 2, in which holes the anchors 4, 5 are fixed. Said anchors 4, 5 have a pin 6, which is inserted into the corresponding hole in the tooth 1, 2, and also have a head 7 with a non-round cross section; see FIG. 5.

In the case of the prosthetic construction according to the invention two fixing parts 8, 9 are used. Said fixing parts each have a non-round opening 10, 11, which fits closely over the corresponding non-round head 7 of a respective anchor 4, 5.

A so-called wing 12 is fixed on the fixing parts 8, 13, which wing ultimately has to be fixed on the inside of the corresponding pillar element 1, 2.

The fixing part 9 fits telescopically and rotatably into the connecting part 14. The fixing part 8 and the cylindrical connecting part 14 are fixed in corresponding openings 15 and 16 respectively of the prosthesis indicated in its entirety by 17.

The dentist places the fixing part 9 in the cylindrical connecting part 14. These two parts are provided with a slot 18, 19, in such a way that they can be pushed over the corresponding anchor 5. In the process, the anchor 5 is accommodated in the opening 11 of the fixing part 9. The fixing part 8 is likewise pushed with its opening 10 over the corresponding anchor 4. The corresponding fixing parts 8, 9 are subsequently cemented down on the anchors 4, 5, and the prosthetic construction is then ready.

In the prosthetic construction according to the invention the set shown in FIGS. 5-10 is used. This set comprises first of all the anchor part 5, the fixing part 9 and the connecting part 14. The anchor part 5 has a pin 6, which is fixed in a prepared hole in a sound pillar element. In addition, said set comprises a non-round head 7 with recessed sides 21, and a recessed top 22 (see also FIG. 8). The fixing part 13 has an opening 11 with a corresponding shape, in other words thickened sides 23 and a recessed top 25 (saddle shape, also see FIG. 8).

The connecting part 14 is cylindrical in shape with an internal cylindrical space 25, which can be pushed in a close fit over the external, likewise cylindrical fixing part 9.

As shown in FIGS. 3 and 4, the fixing part 9 is pushed into the connecting part 14, which is combined with the prosthesis 17. The combination of fixing part 9 and connecting part 14 can then be pushed over the head 7 of the anchor 5, while the fixing part 8 is also pushed over the anchor 4. The fixing parts 9, 8 are cemented fast on their corresponding anchors 5, 4.

As a result of the cylindrical shapes of fixing part 9 and connecting part 14, the anchor 5, and consequently the pillar element to which said anchor is fixed, can perform both translations and rotations relative to the prosthetic construction 17.

As can be seen clearly in FIG. 10, the connecting part 14 is protected well against lateral movement away from the fixing part 9, i.e. movement away from the tooth, owing to the fact that the opening 19 by means of which the connecting part 14 together with the fixing part 9 can be pushed over the head 7 of the anchor 5 extends through an angle of less than 180°, in the example shown approximately 90°. A fixing through corresponding shapes is ensured in this way.

It can be seen in FIGS. 7, 8 and 9 that the fixing part 9 is retained securely on the head 7 of the anchor 5 by corresponding shapes. In addition, these parts are fixed to each other by cementing. The connecting part 14 can also translate and rotate relative to the fixing part 9. A further advantage is that less high standards need be set for the parallelism of the anchors 4, 5.

1. Prosthetic construction between two natural pillar elements (1, 2) in a set of teeth, for the replacement of a tooth, comprising two anchor elements (4, 5), each fixed to a respective pillar (1, 2), and a dental prosthesis (17) provided with two fixing parts (8, 9), each rigidly fixed to a respective anchor (4, 5), one of the fixing parts (9) being movably connected to the prosthesis (17), characterized in that a hollow part (14) is present in the prosthesis (17), and one of the anchors (5) comprises a projection (18) that is movably accommodated in the hollow part (14).

2. Prosthetic construction according to claim 1, in which the movable connection permits a translation.

3. Prosthetic construction according to claim 2, in which the translation is directed from the one pillar element (1) to the other pillar element (2).

4. Prosthetic construction according to claim 2 or 3, in which the movable connection comprises telescopic parts (9, 14).

5. Prosthetic construction according to one of the preceding claims, in which the movable connection permits a rotation.

6. Prosthetic construction according to claim 5, in which the axis of rotation extends from the one pillar element to the other.

7. Prosthetic construction according to claims 5 and 6, in which the telescopic parts (9, 14) have interactive surfaces with a circular cross section.

8. Prosthetic construction according to one of the preceding claims, in which the other fixing part (8) is rigidly connected to the prosthesis.

9. Prosthetic construction according to one of the preceding claims, in which the fixing parts (8, 9) and the anchors (4,5) form integral pairs.

10. Prosthetic construction according to one of claims 1-8, in which the fixing parts (8, 9) and the anchors (4,5) form separate parts and interact with each other by means of non-round shapes.

11. Prosthetic construction according to one of the preceding claims, in which the fixing parts (8, 9) each bear a wing (12) that is fixed to a respective pillar element (1, 2).

12. Set for prosthetic construction according to one of the preceding claims, comprising an anchor element (5) provided with a pin (6) that can be rigidly connected to a natural pillar element in a set of teeth, and a hollow connecting part (14) that can be rigidly connected to a dental prosthesis and can be movably connected to the fixing part (9).

13. Set according to claim 12, in which the connection between the connecting part (14) and the fixing part (13) permits a translation.

14. Set according to claim 12 or 13, in which the connection between the connecting part (14) and the fixing part (9) permits at least one rotation.

15. Set according to claim 13 and 14, in which the connection between the connecting part (14) and the fixing part (13) has an axis of rotation that coincides with the direction of translation.

16. Set according to one of claims 12-15, in which the connecting part (14) grips around the fixing part (9) in such a way that the fixing part (9) and the connecting part (14) are movable in a direction relative to each other and transversely to that direction are blocked relative to each other.

17. Set according to one of claims 12-16, in which the connection between the connecting part (14) and the fixing part (9) is telescopic.

18. Set according to claim 17, in which the telescopic parts (9, 14) have interactive surfaces with a circular cross section.

19. Set according to one of claims 12-18, in which the anchor element (5) is of a non-round shape, and the fixing part (9) is of a corresponding non-round shape and can be pushed laterally over the anchor element (5), thereby forming a close fit.

20. Set according to claim 19, in which the anchor element (5) is saddle-shaped.

21. Set according to claim 19 or 20, in which the fixing part (9) has a hollow (11) that by way of a slot (18) opens into the periphery of the fixing part (9), by way of which slot (18) the anchor element (5) can be pushed into the hollow.

22. Set according to claim 19, 20 or 21, in which the connecting part (14) together with the fixing part (9) connected to it can be pushed laterally over the anchor element (5).

23. Set according to claim 22, in which the connecting part (14) has a hollow (25) that by way of a slot (19) opens into the periphery of the connecting part (14), which slot (19) approximately coincides with the slot (18) in the fixing part (9) combined with the connecting part (14).

24. Set according to claim 23, in which the connecting part (14) has an undercut hollow (25), into which the fixing part (9) can be pushed.

25. Set according to claim 24, in which the connecting part (14) has a closed end wall (20) and is open on the opposite side, in such a way that the fixing part (9) can be pushed into the connecting part (14) by way of the open side.

26. Set according to one of claims 12-25, in which the anchor element (5) has a pin (6) that can be fixed in a hole drilled in a natural pillar element.
